(19) United States
(12) Patent Application Publication
(10) Pub. No.: US 2019/0241055 A1
(43) Pub. Date: Aug. 8, 2019

(54) SINGLE SHOT EXTRUSION OF GLASS RUN CHANNEL

(71) Applicant: MAGNA CLOSURES INC., Newmarket (CA)

(72) Inventor: Mario MAGAZZINI, Livorno (IT)

(21) Appl. No.: 16/264,762

(22) Filed: Feb. 1, 2019

Related U.S. Application Data
(60) Provisional application No. 62/627,359, filed on Feb. 7, 2018.

(51) Int. Cl. B60J 10/76; B60J 10/16; B60J 10/17; B60J 10/00; B60J 10/277

(52) U.S. Cl. CPC B60J 10/76; B60J 10/16; B60J 10/277; B60J 10/45; B60J 10/17

(57) ABSTRACT

A weather strip formed from at least two materials having distinct physical properties and a corresponding glass run channel. In particular, the weather strip includes a base portion and two sidewalls located on opposite edges of the base portion. The base portion and sidewalls each include a strip of first material and joints between the base portion and the sidewalls each include a strip of second material more flexible than the first material. The weather strip further includes at least one projection and the glass run channel includes at least one opening for establishing a press fit engagement with the at least one projection. In addition to the first two materials, the weather strip may also be formed of an additional third material having a low friction index and located to come into direct contact with a windowpane. The weather strip is co-extruded out of the first and second material.

### CROSS-REFERENCE TO RELATED APPLICATION

This application claims the benefit of and priority to U.S. Provisional Patent Application Ser. No. 62/627,359, filed on Feb. 7, 2018, the entire disclosure of which is hereby incorporated by reference.

### FIELD

The present disclosure generally relates to a weather strip and a glass run channel. More particularly, the present disclosure is directed to weather strip and a corresponding glass run channel for use in an automobile.

### BACKGROUND OF THE INVENTION

This section of the written disclosure provides background information related to weather strips adopted for use in corresponding glass run channels and is not necessarily prior art to the inventive concepts disclosed and claimed in this application.

There is a continuing effort to advance the operation of motor vehicles through improvements in safety, efficiency, and comfort. One important part of a motor vehicle that can greatly impact its operation are the windows. At their most basic functionally, windows are a transparent barrier between the outside and the inside of the motor vehicle. Windows need to operate at various wind speeds and in various temperatures, protecting an operator and passengers from harsh conditions outside. More than just forming a barrier, windows should also ideally seal against the motor vehicle body by at least partially seating within a glass run channel. The seal prevents air, water, and other unwanted elements from effecting the comfort and safety of the operator and passengers. Moreover, many types of windows in motor vehicles, such as the driver and passenger side windows, must be able to regularly open and close without negatively impacting the seal upon closing. In addition to helping form a seal, glass run channels are typically located along at least one side of a window sash and guide the window during opening and closing. When the window is open or partially open it is at least partially located inside a cavity in the vehicle body and when the window is closed it is at least partially seated within the glass run channel.

To form a complete and impermeable seal between the window and the motor vehicle body, a weather strip formed of elastomeric material is fit within the glass run channel to provide a flexible and non-abrasive surface. Many traditional weather strips have a U-shape structure that is installed into the glass run channel. These traditional weather strips generally include a base portion for abutting the edge of the window and sidewalls that come into direct sliding contact with sides of the window as it is being opened or closed. When closed, the weather strip is at least partially compressed by the window to create a substantially impermeable seal between the window and the glass run channel. In addition to providing an impermeable seal, weather strips provide dampening functionality to prevent the window from over flexing and ultimately breaking. The damping functionality further limits vibrations caused through internal and external environmental factors to limit the shaking noise associated with a vibrating window. Moreover, the sidewalls can further be configured to limit dirt and other unwanted elements from building up in the glass run channel or the weather strip and forming abrasions on the window during opening and closing.

However, even with these advancements, weather strips continue to suffer from certain drawbacks. During installation, for example, when placing the flexible weather strip into the glass run channel, the weather strip is oftentimes deformed and does not properly seat within the glass run channel. When not properly seated, the weather strip will remain in a deformed state and define non-linear sealing edges such that gaps are formed between the window and weather strip. When a weather strip doesn't properly seal, water, air, and other unwanted elements can enter the vehicle thus negatively impacting climate control efficiency, wind, and vibrational noises. Additionally, accumulation of these unwanted elements are also known to rust and otherwise damage parts of the vehicle. For example, dirt and other unwanted granules enter the gaps and accumulate within the weather strip to create an abrasive surface from which the window must come into sliding contact with.

In view of the foregoing, a need exists to develop an improved weather strip that includes an arrangement less susceptible to improper installation and wear during continued use.

### SUMMARY OF THE INVENTION

This section provides a general summary of the inventive concepts associated with this disclosure and is not intended to be interpreted as a complete and comprehensive listing of all of its aspects, objectives, features, and advantages.

One aspect of the present disclosure is to provide a weather strip constructed of at least two materials of varying rigidity to allow deformation and facilitate proper seating within a glass run channel while still maintaining rigidity.

Another related aspect of the present disclosure to provide weather strip for a window in a motor vehicle comprising a base portion that extends lengthwise between a first end and a second end and widthwise between a first edge and a second edge. The weather strip includes a first sidewall coupled to the first edge of the base portion via a first joint and a second sidewall coupled to the second edge of the base portion via a second joint. The sidewalls are at least partially formed from a first material and at least one of the joints are at least partially formed of a second material. The first material is more rigid than the second material. In accordance with another aspect, the base portion is at least partially formed from a first material.

In another related aspect, the present disclosure provides a first sealing member coupled to the first sidewall and a second sealing member coupled to the second sidewall. The first sealing member and the second sealing member being located opposite the base portion and extending towards each other. The first sealing member and the second sealing member at least partially formed of the second material. The first sealing member and second sealing member both include an external sealing member surface for direct contact with a windowpane during opening and closing. The external sealing member surface includes a third material having a lower friction index than the first material and the second material for providing a non-abrasive contact surface for the windowpane. The base portion includes an interior base surface facing the sealing members, the interior base surface at least partially formed of the third material. The first sidewall and the second sidewall both including interior sidewall surfaces facing each other, both interior sidewall surfaces at least partially formed of the third material. The third material of the sealing members and the third material of the sidewalls form a substantially continuous surface of third material from the sealing members to the base portion when the sealing members are pressed inwardly against the sidewalls as the windowpane is closed.

In another related aspect, the third material of the sealing members and the third material of the sidewalls come into contact when the sealing members are pressed inwardly against the sidewalls as the windowpane is closed.

In yet another aspect, at least one of the first sidewall, the second sidewall, or the base portion includes at least one projection for press fitting into an opening of a corresponding glass run channel, the projection formed of the first material or the second material. The at least one projection includes a projection on the base portion and a projection on at least one of the first sidewall and the second sidewall.

In another aspect, both of the joints are formed by a continuous substructure strip of second material that extends at least partially along the first sidewall, at least partially along the second sidewall, and entirely across the base portion. The substructure strip further includes hooks extending outwardly for mating with an opening in a corresponding glass run channel.

It is another aspect that first material is polypropylene, the second material is thermoplastic elastomer, and the third material is polyethylene resin.

The present disclosure further provides a weather strip for a window in a motor vehicle comprising a composite structure including a base portion, a pair of sidewalls, and a pair of sealing members. The base portion extends lengthwise between a first end and a second end and widthwise between a first edge and a second edge. The pair of sidewalls include a first sidewall coupled to the first edge of the base portion via a first joint and a second sidewall coupled to the second edge of the base portion via a second joint. The pair of sealing members include a first sealing member coupled to the first sidewall and a second sealing member coupled to the second sidewall, the first sealing member and the second sealing member are located opposite the base portion and extend towards each other. Each of the sidewalls are primarily formed from a strip of a first material and each of the sealing members are at least partially formed of a strip of a second material. The first material is more rigid than the second material.

It is a related aspect to provide a substructure strip of second material that extends between the first sidewall, the second sidewall, and across the base portion and further includes the first joint and the second joint.

In yet another related aspect, the first sealing member and second sealing member both include an external sealing member surface for direct contact with a windowpane during opening and closing. The external sealing member surface includes a third material having a lower friction index than the first material and the second material to provide a non-abrasive surface.

In another related aspect, the present disclosure includes at least one of the first side wall sidewall, the second sidewall, or the base portion includes at least one projection for press fitting into an opening of a corresponding glass run channel, the projection formed of the first material or the second material. Wherein the projection is preferably formed of the first material.

The present disclosure further provides a weather strip for a window of a motor vehicle and a weather strip holding fixture with a corresponding channel for insertion of the weather strip. The weather strip has a composite structure of a first material and a second material more flexible than the first material. The composite structure further includes a base portion and at least one sidewall. The base portion extends lengthwise between a first end and a second end and widthwise between a first edge and a second edge wherein the at least one sidewall includes a first sidewall coupled to the first edge of the base portion. The weather strip holding fixture defines the channel and includes a bottom portion corresponding to the base portion of the weather strip and a side portion corresponding to the at least one sidewall of the weather strip. At least one projection extends from the base portion or the at least one sidewall of the weather strip and at least one opening extends at least partially into the bottom portion or the side portion of the channel in press fit engagement with the at least one projection.

It is a related aspect that the weather strip holding fixture has an L-shape profile that includes the bottom portion and one side portion.

Further areas of applicability will become apparent from the description provided herein. The description and specific examples in this summary are intended for purpose of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial side view of a motor vehicle having a window and a weather strip sealing the window;

FIG. 2A is an isometric view of a first end of the weather strip in accordance with one embodiment of the subject disclosure;

FIG. 2B is an isometric view of a second end of the weather strip in accordance with one embodiment of the subject disclosure;

FIG. 3A is a cross-sectional view of the weather strip illustrating the multiple materials included in forming the weather strip from FIGS. 2A and 2B;

FIG. 3B illustrates a windowpane inserted into the weather strip of FIG. 3A;

FIGS. 3C to 3E are a series of cross-sectional views illustrating an insertion of the weather strip of FIG. 2A into a channel, in accordance with an illustrative embodiment;

FIGS. 4A through 4D are various views of a carrier module that retains the weather strip in a channel in accordance with one embodiment of the subject disclosure;

FIG. 5 is a sectional view of the weather strip press installed into the corresponding glass run channel in accordance with one embodiment of the subject disclosure;

FIG. 6 is a flow chart illustrating a method of co-extruding the weather strip; and

FIG. 7 is a flow chart illustrating a method of installing the weather strip into the glass run channel.

### DETAILED DESCRIPTION

Example embodiments will now be described more fully with reference to the accompanying drawings. In particular, a number of non-limiting embodiments of a weather strip and corresponding glass run channel are provided so that this disclosure will be thorough and will fully convey the true and intended scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “compromises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “interior,” “exterior,” “inner,” “outer,” “beneath,” “below,” “lower,” “above,” “upper,” and the like, may be used herein for ease of description to describe one element or feature's relationship to another element(s) or feature(s) as illustrated in the FIGS. Spatially relative terms may be intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the example term “below” can encompass both an orientation of above and below.

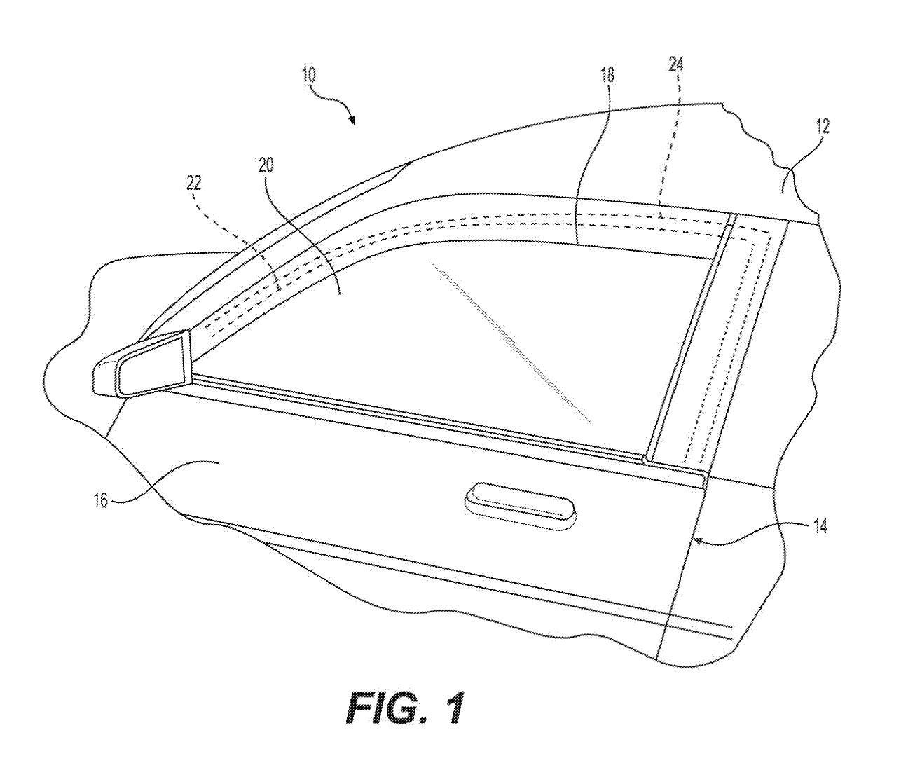

Referring initially to FIG. 1, a partial side view of a motor vehicle 10 is shown. The motor vehicle includes a vehicle body 12 and at least one door 14. The door 14 includes a body portion 16 and a window frame portion or sash 18. The door 14 further includes a windowpane 20 fit within the sash 18. The windowpane 20 can be located in a closed position, as illustrated in FIG. 1, in which the windowpane 20 functions as a barrier between outside and inside of the vehicle body 12. The windowpane 20 further can be located in an open position (not shown) in which the windowpane 20 slides into the body portion 16. The window frame portion 18 acts as a weather strip holding fixture and includes a glass run channel 22 defining a gap for guiding and retaining the windowpane 20 in the closed or at least partially closed position. A weather strip 24 is located in the glass run channel 22 for providing a seal between the window frame portion 18 and the windowpane 20. As will be described in further detail below, the weather strip 24 is preferably formed of flexible material, more preferably extruded from elastomer material, and even more preferably yet co-extruded out of more than one material.

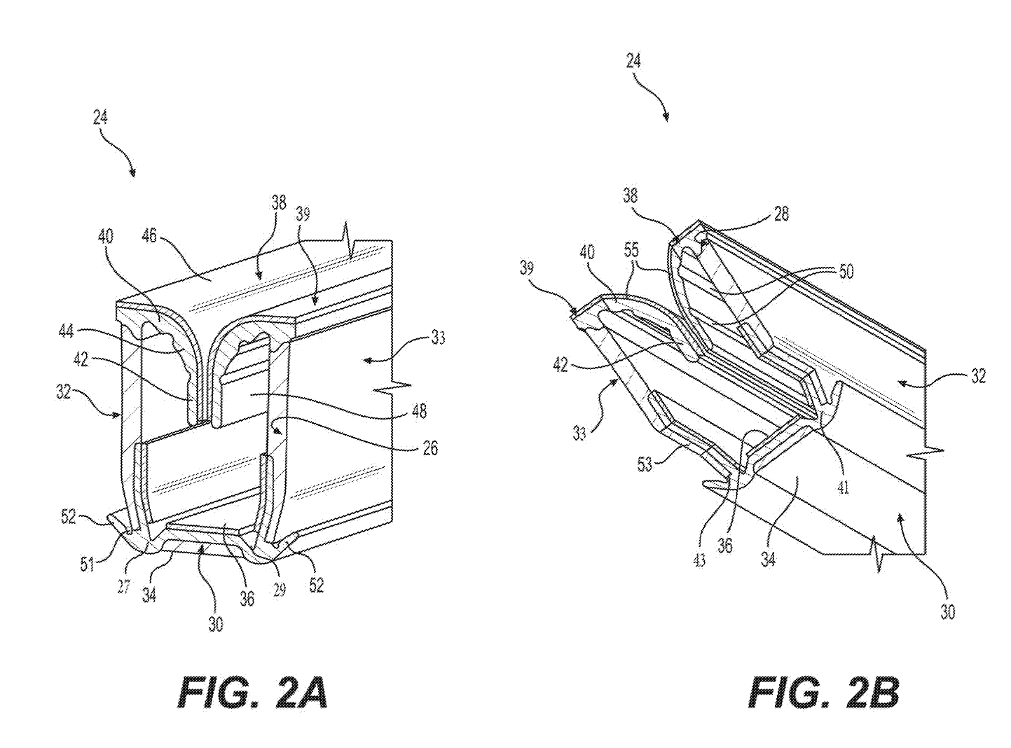

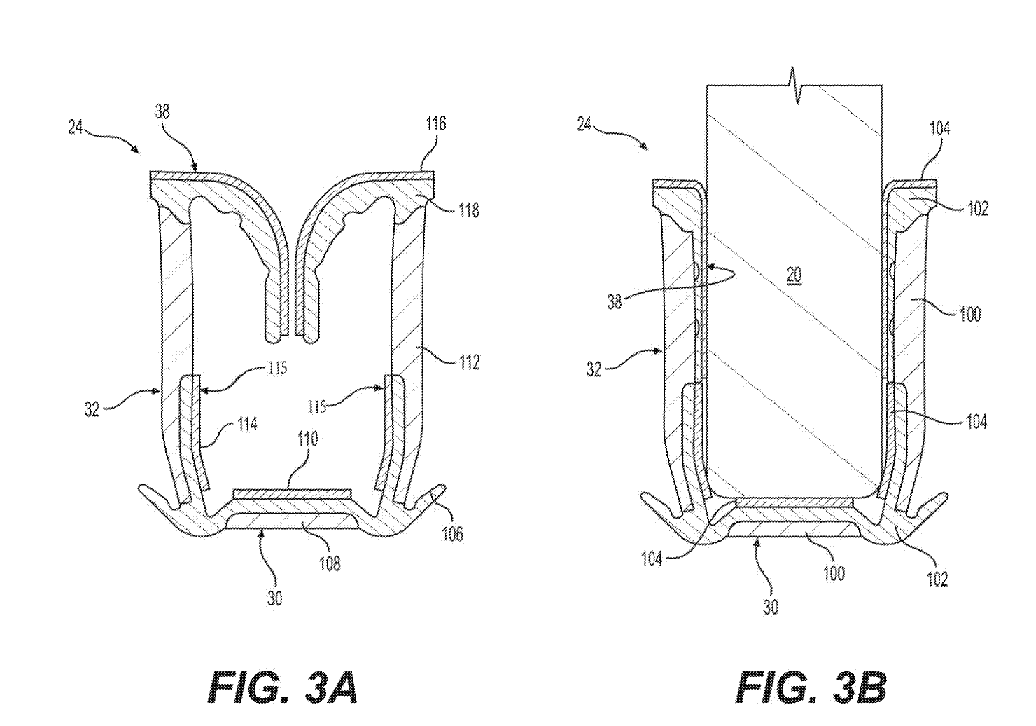

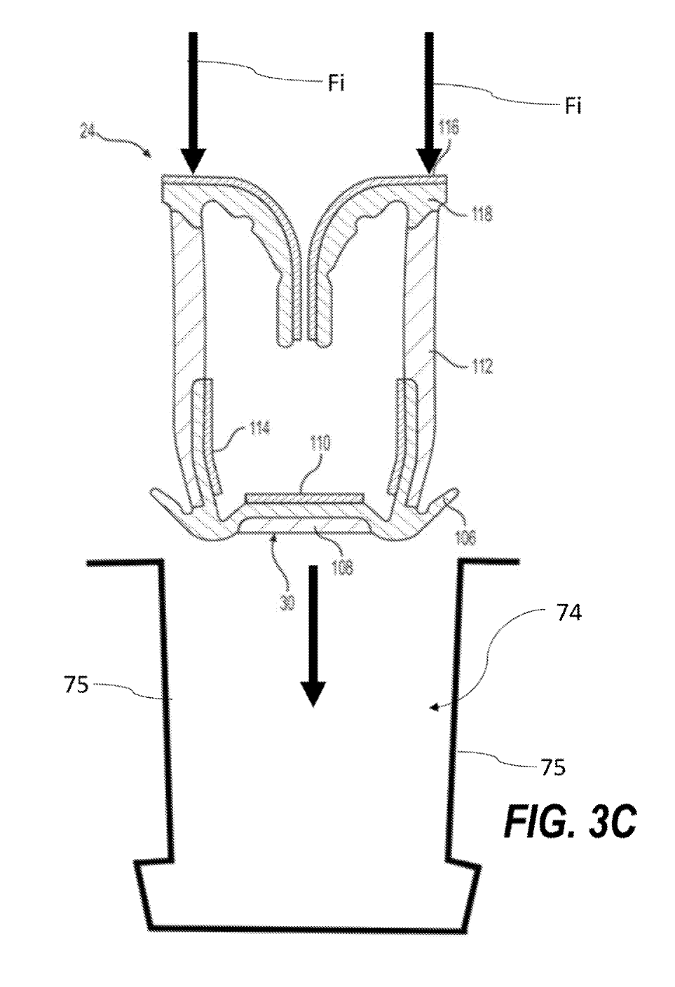

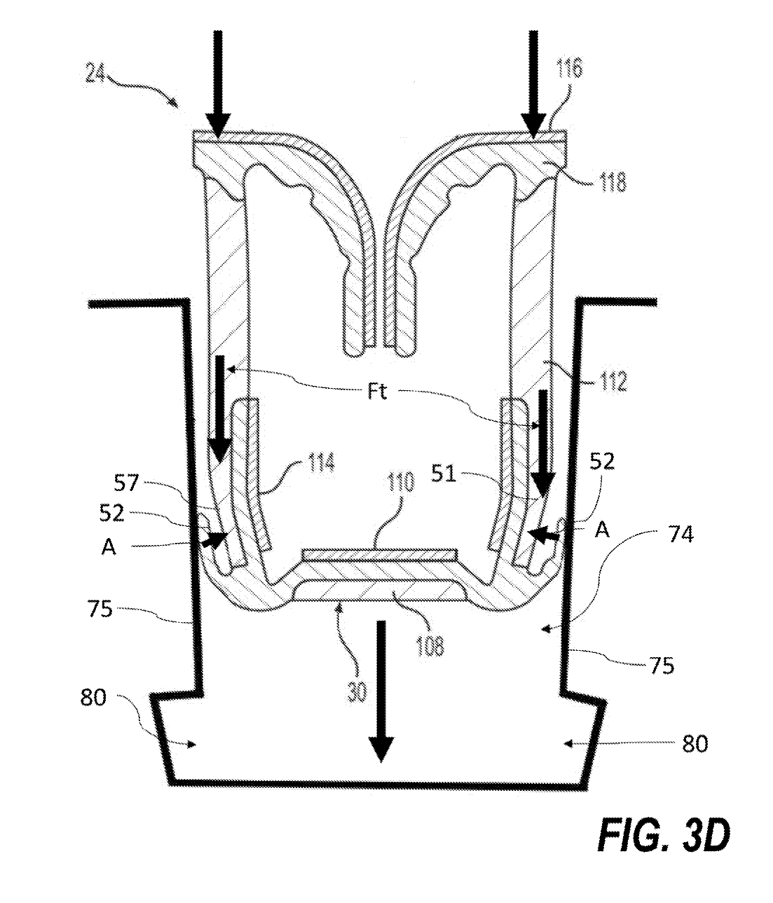

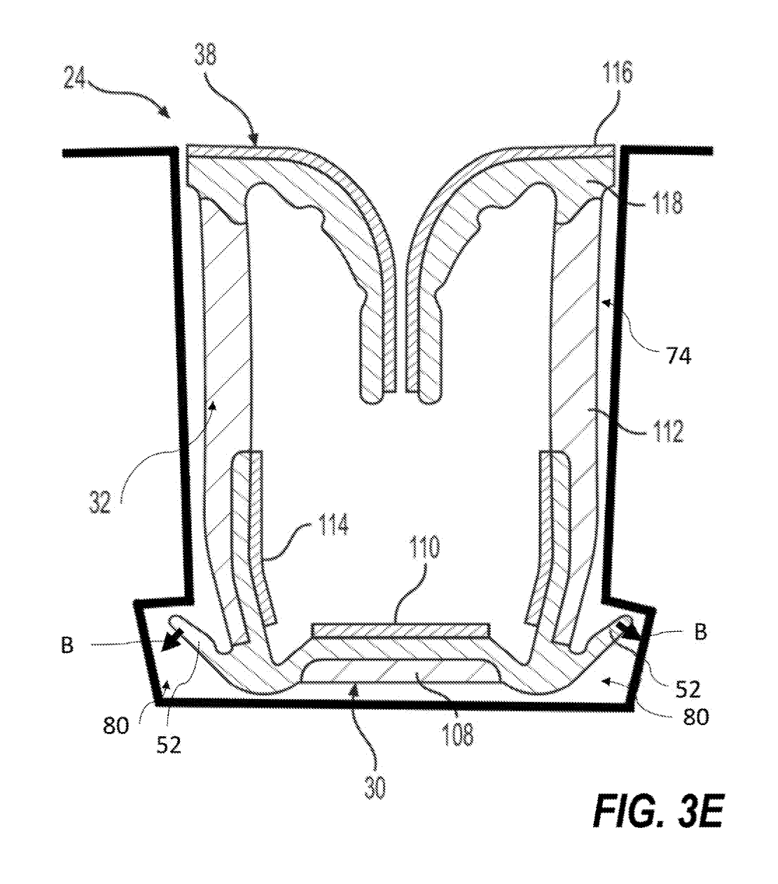

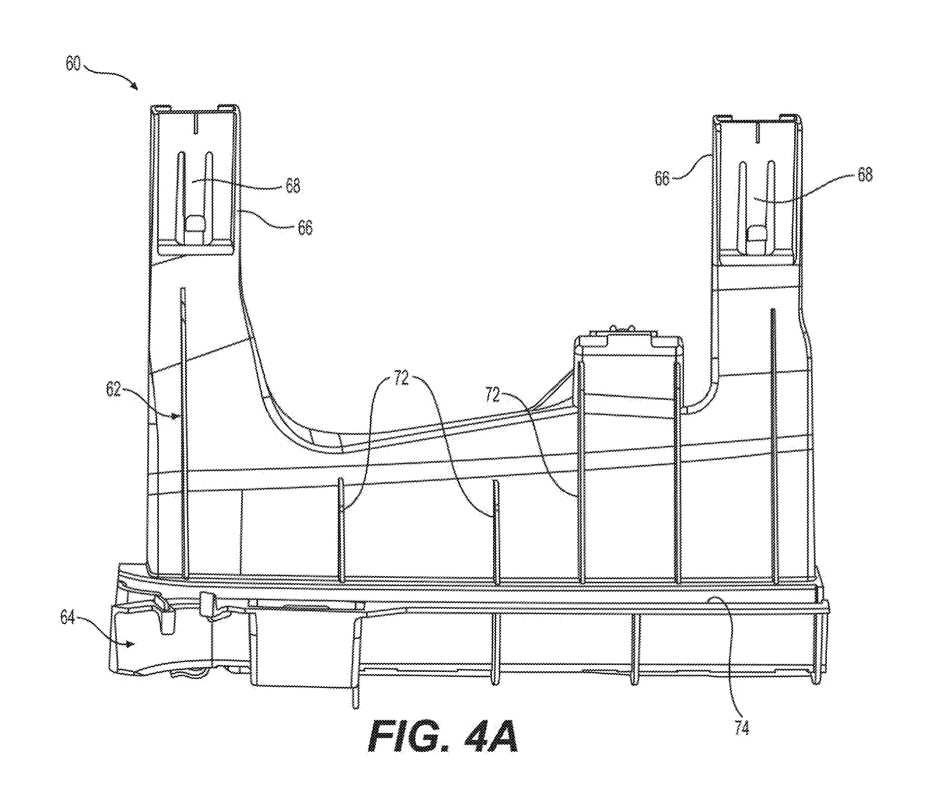

FIGS. 2A through 3B illustrate the weather strip 24 according to one aspect of the subject disclosure. The weather strip 24 extends lengthwise between a first end 26 (FIG. 2A) and a second end 28 (FIG. 2B) and has a cross-sectional profile that includes a base portion 30 and a pair of sidewalls 32, 33 extending from opposite widthwise edges of the base portion 30. The edges include a first edge 27 and a second edge 29 (as indicated in FIG. 2A). The pair of sidewalls including a first side wall 32 and a second sidewall 33. The base portion 30 includes an exterior base surface 34 that directly interfaces with a bottom portion of the glass run channel 22. The base portion 30 further includes an interior base surface 36 opposite from the exterior base surface 34 that provides a seat that abuts the windowpane 20 when the windowpane 20 is in the closed position. The base portion 30 is at least partially flexible to compress as it receives pressure from the windowpane 20 and create a seal. The sidewalls 32, 33 extend in a parallel relationship from the interior base surface 36 to a pair of sealing members 38, 39 that extend towards each other. The sealing members preferably including a first sealing member 38 and a second sealing member 39. More specifically, the sealing members 38, 39 extend towards each other until they come into contact with one another or are at least closely spaced to one another so that when the windowpane 20 is moved into the closed position it presses into and separates the sealing members 38, 39.

The sealing members 38, 39 include first segments 40 extending towards one another and second segments 42 that extend downwardly towards the base portion 30. Between the first segments 40 and the second segments 42 is a bend 44. The sealing members 38, 39 include an external sealing member surface 46 that comes into sliding engagement with the windowpane 20 as it is opened and closed. Each of the sealing members 38, 39 further include an internal sealing member surface 48 opposite the external sealing member surface 46. The internal sealing member surface 48 defines a plurality of grooves 50, preferably extending lengthwise therealong, for providing additional flexibility to the sealing members 38, 39 during the opening and closing action of the windowpane 20. A pair of hooks 52 are located on opposite sides of the base portion 30 and extend outwardly widthwise for press fitting into an accompanying structure of the corresponding glass run channel 22. The hooks 52 may include one or more grooves 51 to increase flexibility. As illustrated in FIG. 2B, the second end 28 of the weather strip 24 may include one or more steps 53 or cutouts 55 to facilitate installation and attachment to the window frame portion 18 or glass run channel 22.

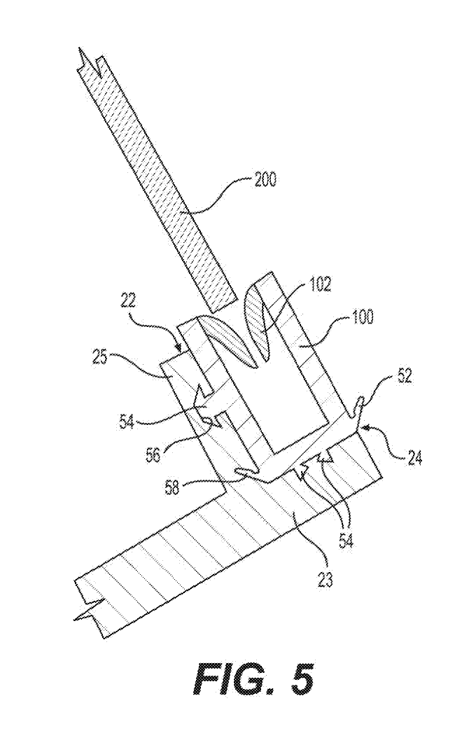

In other embodiments, the base portion 30, the sidewalls 32, 33, and/or the sealing members 38, 39 may additionally include projections 54 (FIG. 5) having various shapes that extend outwardly from an external surface for mating with corresponding structures in the glass run channel 22. While not limited to this list, these projections 54 can be hook-shaped, arrow-shaped, wedge-shaped, or any other suitable shape for press installation. One exemplary example is illustrated in FIG. 5, the projections 54 include an arrow-shape and the glass run channel 22 includes corresponding openings 56 for receiving the arrow-shaped projections 54. More specifically, the weather strip 24 illustrated in FIG. 5 includes two wedge-shaped projections 54 extending from the exterior base surface 24 and an arrow-shaped projection 54 extending from at least one sidewall 34, wherein all the projections 54 can be pressed into corresponding openings 56 of the glass run channel 22. The weather strip 24 further includes a hook 52 that mates with a corresponding groove 58 in the glass run channel 22 via press fit installation. These corresponding structures ultimately simplify and ensure proper installation while preventing long term deformation of the weather strip 24. Furthermore, because of the presence of corresponding press-fit structures in the glass run channel 22 and weather strip 24, the glass run channel 22 is no longer limited to the conventional U-shape (grooved) design. As shown in FIG. 5, the glass run channel 22 can be L-shaped and includes a bottom portion 23 and one side portion 25. Preferably, in this embodiment the weather strip 24 includes at least one projection 54 on one sidewall 32 but not the other sidewall 32.

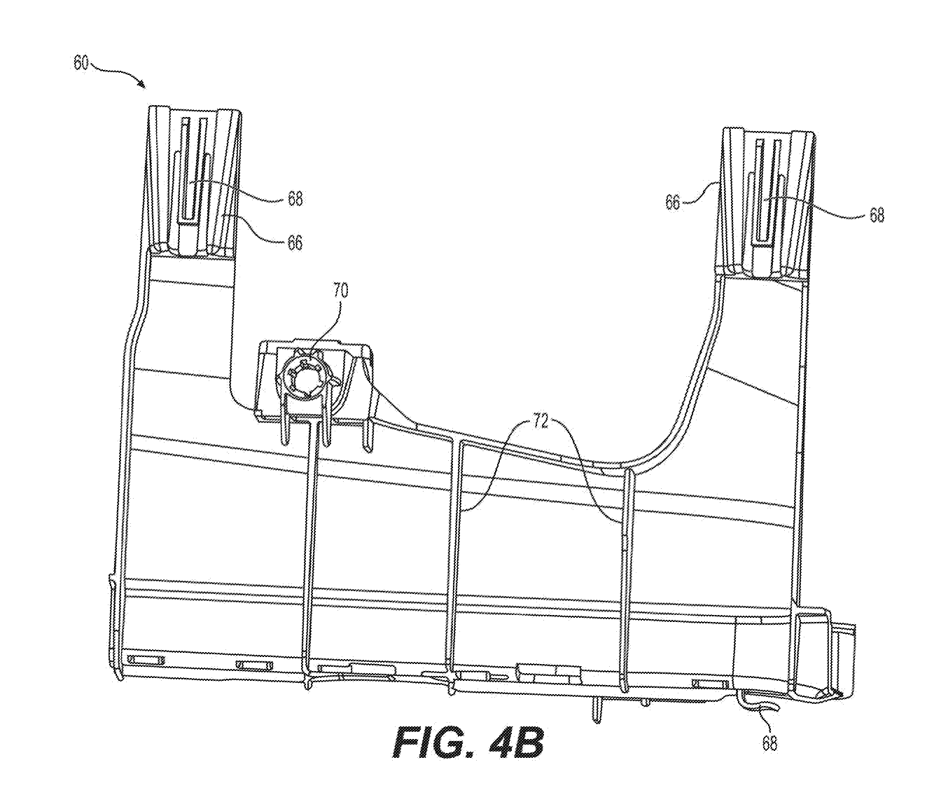

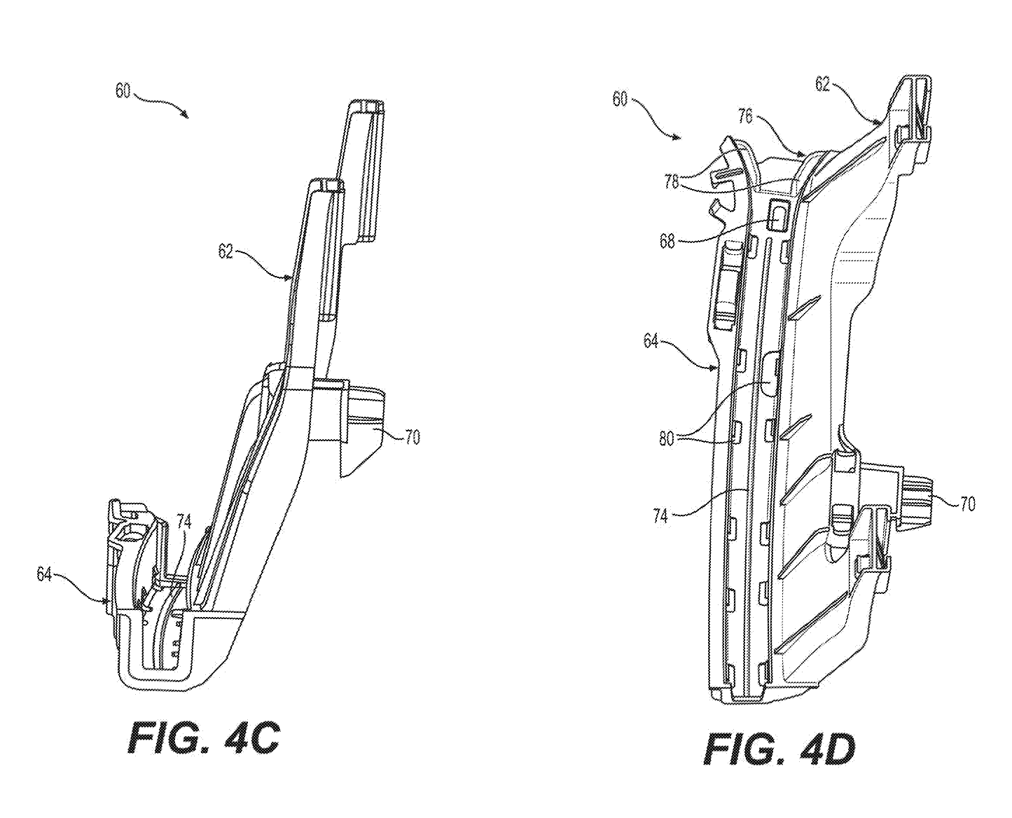

Referring now to FIGS. 4A through 4D, a carrier module 60 for fitting into the body portion 16 of the door 14 is shown. The carrier module 60 guides the windowpane 20 through the body portion 16 when the windowpane 20 is in an open or substantially open position. Movement of the windowpane 20 between the open and closed positions is actuated via a regulator unit (not shown). The carrier module 60 includes a frame portion 62 and a guide portion 64 or weather strip holding fixture. The frame portion 62 includes two elongated members 66 extending to clips 68 for attachment to an inside of the body portion 16 of the door 14. The frame portion 62 further includes a peg 70 (FIG. 4B) for slotting into a corresponding structure of the inside of the body portion 16 of the door 14. Structural webbing 72 reinforces the frame portion 62. The guide portion 64 includes channel 74 for fitting additional weather stripping. As best shown in FIG. 4D, the channel 74 includes an entry end 76 that directs the windowpane 20 towards the channel 74. The entry end 76 includes a pair of flexible guiding members 78 that provide flexibility as the windowpane 20 is guided into the channel 74. The guide portion 64 can further include one or more attachment members such as clips 68. Much like the glass run channel 22, the channel 74 of the guide portion can further include openings 80 for accommodating press installation of projections 54 on the weather strip 24.

In accordance with one aspect of the present disclosure, the weather strip 24 is a composite structure comprising more than one material having different physical properties. More particularly, in accordance with the embodiment shown in FIGS. 2A-3B, the weather strip 24 is co-extruded from three distinct materials. As best illustrated in FIGS. 3A and 3B, the weather strip 24 preferably includes a first material 100, a second material 102, and a third material 104. The first material 100 has rigidity relatively high in compression to at least the second material 102 and also preferably the third material 104. The second material 102 has relatively high flexibility relative to the first material 100 and preferably also relative to the third material 104. The third material 104 has a low friction index relative to at least the second material 102 and preferably also relative to the first material 100. As one non-limiting example, the first material 100 includes polypropylene (PP), the second material 102 includes thermoplastic elastomer (TPE), and the third material 104 includes a low friction polyethylene resin. However, it should be appreciated that other materials, polymers, resins, could be used and that the weather strip 24 could include only one material, but preferably at least two materials, and more preferably at least three materials with distinct physical properties. As will be described in greater detail below, while the weather strip 24 is preferably completely formed via a co-extrusion process, certain portions, such as the third material 104 could be coated on after extrusion or co-extrusion of the first material 100 and second material 102.

As best illustrated in FIG. 3B, a substructure strip 106 is preferably formed from the second material 102 and extends down at least part of one sidewall 32, along the base portion 30, and up at least part of the other sidewall 32. The substructure strip 106 also preferably includes the hooks 52. A base rigid strip 108 is located under the substructure strip 106 and preferably comprises the first material 100 to add rigidity to the base portion 30. The base rigid strip 108 terminates before the sidewalls 32, 33 such that the point of connection (first joint 41 and second joint 43 as indicated in FIG. 2B) between the base portion 30 and sidewalls 32, 33 does not include the rigid first material 100 but instead includes the flexible second material 102. Accordingly, the sidewalls 32, 33 are allowed to flex relative to one another during installation and use. A base low friction strip 110 is provided on top of the substructure strip 106 and corresponds to the exterior base surface 34. The base low friction strip 110 comes into direct contact with the windowpane 20 to provide a non-abrasive surface. The sidewalls 32, 33 are preferably predominately the first material 100 to add rigidity and prevent over deformation and/or permanent deformation after compression and/or deformation of the weather strip 24. More specifically, while at least a portion of the sidewalls 32, 33 include the substructure strip 106 as described above, the sidewall 32 structure primarily consists of a sidewall strip 112 of first material 100 that extends from a portion of the sidewall 32 adjacent to the base portion 30 along the substructure strip 106 to the sealing members 38, 39. A sidewall low friction strip 114 is preferably constructed of the third material 104 extends along an interior sidewall surface 115 (as indicated in FIG. 3A) that is opposite side of the substructure strip 106 and from the sidewall strip 112 such that it is positioned to contact the windowpane 20.

With continued reference to FIG. 3B, the sealing members 38, 39 include a low friction sealing member strip 116 preferably formed of the third material 104 that correspond to the external sealing member surface 46. The sealing members 38, 39 further include flexible sealing member strips 118 preferably formed of the second material 102. The low friction sealing member strip 116 provides a non-abrasive surface while the flexible sealing member strip 118 allows the sealing members 38, 39 to be displaced as the windowpane 20 is moved between the open position and the closed position. As best shown in cross-section illustrated in FIG. 3B, the first segment 40 and second segment 42 of the sealing members 38, 39 extend a length such that when the windowpane 20 is inserted into the weather strip 24, the low friction sealing member strip 116 and the sidewall low friction strip 114 cover all or substantially all of an inner portion of the sidewalls 32, 33. Such an arrangement of the third material 104 insures that the windowpane does not contact the potentially abrasive rigid sidewall strip 112. As a slight variation to FIG. 3B, the sidewall low friction strip 114 can be thicker and extend further into the weather strip 24 over the substructure strip 106 such that the low friction sealing member strip 116 can sit flush with the sidewall low friction strip 114 when the windowpane 20 is inserted.

Now referring to FIGS. 3C to 3E, there is illustrated an assembly of the weather strip 24 with a channel by insertion, such as insertion into the channel 74 of carrier module 60 in accordance with an illustrative embodiment. Weather strip 24 receives an insertion force Fi, which may be applied to a top portion of the weather strip 24 by the fingers or hand of an installer. Insertion force Fi will urge the weather strip 24 towards the channel 74 for receipt therein. Continued application of insertion force Fi will cause weather strip 24 to be guided within channel 74 along opposite channel walls 75 as illustrated in FIG. 3D. At a point of entry of the weather strip 24 received within channel 74, hooks 52 will be caused to deform inwardly as represented by arrows A by engagement of the hooks 52 with the side walls 32 as illustrated in FIG. 3D. Side walls 32 are provided with an inwardly flared end portion 57 to allow for hooks 52 to inwardly deform to facilitate insertion without increasing insertion efforts. Transfer of insertion force Fi from the top portion of the weather strip 24 will be guided towards the hooks 52 by the rigid sidewalls 32, 33 as illustrated by arrows Ft, such that rigid side walls 32 do not deform or buckle for example inwardly buckle or deform during the application of the insertion force Fi. Base rigid strip 108 also ensures that rigid side walls 32 are prevent from deforming away from channel walls 75 during insertion of the weather strip 24. Hooks 52 therefore remain in a position proximate side walls 32 and in a position to engage a latching feature or notch in provided in the sidewalls 32, 33, and illustrated as openings 80 but can also include groove 58 (FIG. 8), upon clearing side walls 32 allowing hooks 52 to resiliently return to their initial position as shown in FIG. 3E and as represented by arrows B. Weather strip 24 is thus properly seated within channel 74 without having to require additional assembly steps for positioning or correcting for any deformations of the weather strip 24 caused during insertion for properly seating the weather strip 24 within channel 74. Hooks 52 are also maintained in position during insertion for receipt within openings 80.

Referring now to the embodiment illustrated in FIG. 5, the weather strip 24 is preferably primarily formed of the first material 100. More specifically, the base portion 30, sidewalls 32, 33, hooks 52, and projections 54 are formed of the first material 100 while the sealing members 38, 39 are formed of at least one of the second material 102 or third material 104. Because the glass run channel 22 is L-shaped, installation with a more rigid weather strip 24 is simplified as there is a reduced chance of improper installation and permanent deformation.

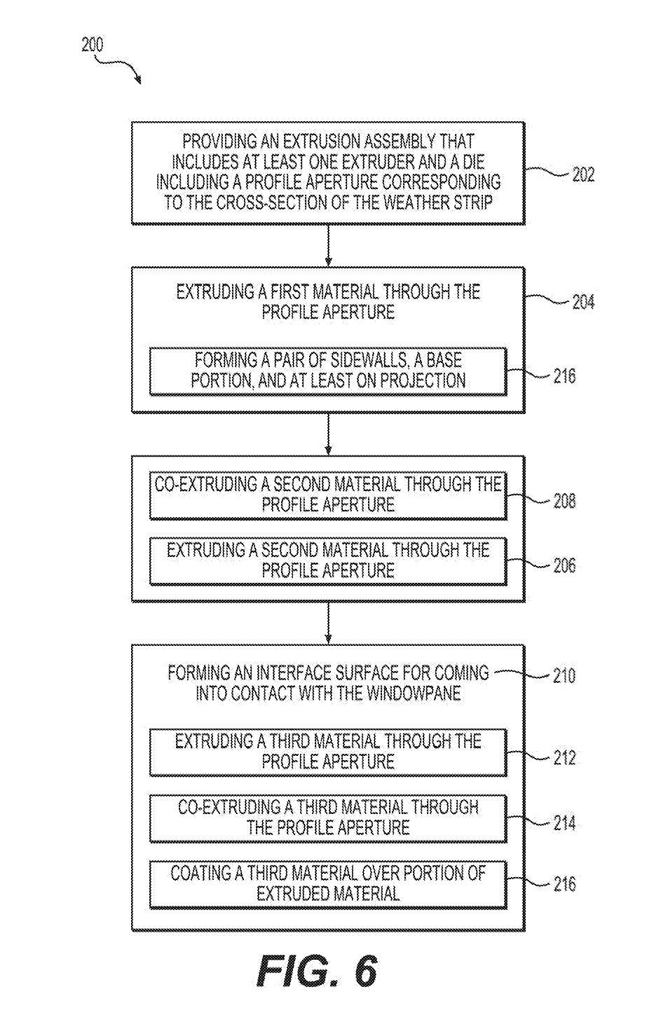

As it should be appreciated, the weather strip 24 includes a method 200 of assembly. Referring now to FIG. 6, the method 200 includes a step 202 of providing an extrusion assembly that includes at least one extruder and a die including a profile aperture corresponding to the cross-section of the weather strip. The next step 204 includes extruding a first material through the profile aperture. The method 200 further includes a step 206 of extruding the second material through the profile aperture at a later time or alternatively a step 208 of simultaneously co-extruding the second material through the profile aperture with a second extruder. In certain embodiments, the method 200 can be followed by a step 210 of forming an interface surface for coming into contact with the windowpane, which may include a step 212 of extruding or a step 214 of co-extruding the third material through the profile aperture. Alternatively, the method may include a step 216 of coating a portion of the extruded material in the third material. The step 204 of extruding the first material can further include a step 216 of forming sidewalls, a base portion, and at least one projection. The step 206 or the step 212 may correspondingly further include a step of forming a connection between the sidewalls and the base portion.

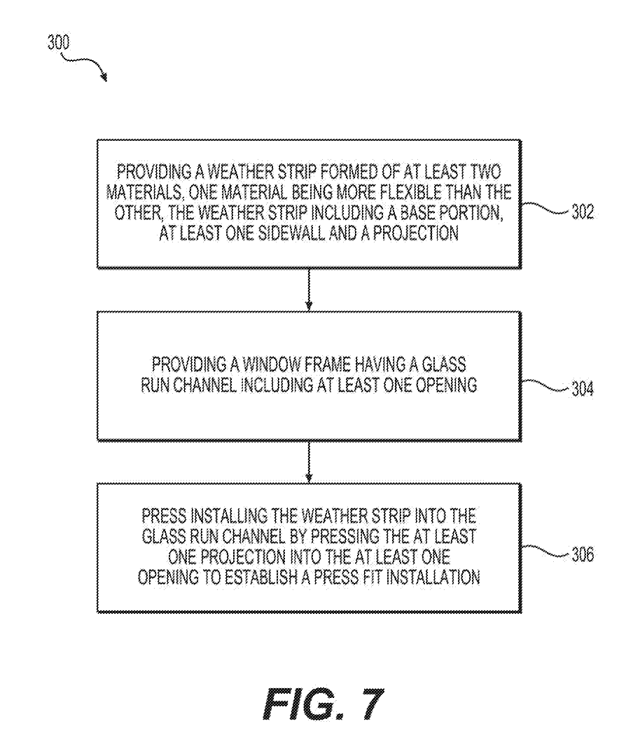

The present disclosure further includes a method 300 of installation is shown in FIG. 7. The method 300 includes a step 302 of providing a weather strip formed of at least two materials, the weather strip including a base portion and at least one sidewall. The weather strip further including at least one projection on at least one of the sidewalls, the base portion, or a projection on both the base portion and the at least one sidewall, the projections having an expanded end such as a wedge or arrow shape and being formed of one of the first material or the second material. The method 300 further includes a step 304 of providing a window frame having a glass run channel including at least one opening. The next step 306 includes press installing the weather strip into the glass run channel by pressing the at least one projection on the sidewall into one of the openings and/or pressing the at least one projection on the base portion into one of the openings to establish a press fit installation. The step 302 may also include providing a weather strip having at least one projection on both of a pair of sidewalls. The step 306 may further include pressing the at least one projection on one sidewall and the at least one projection on the other sidewall into respective openings to establish a press fit installation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A weather strip for a window in a motor vehicle comprising:
a base portion extending lengthwise between a first end and a second end and widthwise between a first edge and a second edge;
a first sidewall coupled to the first edge of the base portion via a first joint and a second sidewall coupled to the second edge of the base portion via a second joint;
the sidewalls at least partially formed from a first material;
at least one of the joints being at least partially formed of a second material; and
wherein the first material is more rigid than the second material.

2. The weather strip according to claim 1 further including a first sealing member coupled to the first sidewall and a second sealing member coupled to the second sidewall, the first sealing member and the second sealing member being located opposite the base portion and extending towards each other, wherein the first sealing member and the second sealing member are at least partially formed of the second material.

3. The weather strip according to claim 2 wherein the first sealing member and the second sealing member both include an external sealing member surface for direct contact with a windowpane during opening and closing, and wherein the external sealing member surface includes a third material having a lower friction index than the first material and the second material for providing a non-abrasive contact surface for the windowpane.

4. The weather strip according to claim 3 wherein the base portion includes an interior base surface facing the sealing members, and wherein the interior base surface is at least partially formed of the third material.

5. The weather strip according to claim 4 wherein the first sidewall and the second sidewall both include interior sidewall surfaces facing each other, and wherein both interior sidewall surfaces are at least partially formed of the third material.

6. The weather strip according to claim 5 wherein the third material of the sealing members and the third material of the sidewalls form a substantially continuous surface of third material from the sealing members to the base portion when the sealing members are pressed inwardly against the sidewalls as the windowpane is closed.

7. The weather strip according to claim 6 wherein the third material of the sealing members and the third material of the sidewalls come into contact when the sealing members are pressed inwardly against the sidewalls as the windowpane is closed.

8. The weather strip according to claim 1 wherein at least one of the first sidewall, the second sidewall, and the base portion includes at least one projection for press fitting into an opening of a corresponding glass run channel, and wherein the at least one projection is formed of the first material or the second material.

9. The weather strip according to claim 8 wherein the at least one projection includes a projection on the base portion and a projection on at least one of the first sidewall and the second sidewall.

10. The weather strip according to claim 1 wherein both of the joints are formed by a continuous substructure strip of second material that extends at least partially along the first sidewall, at least partially along the second sidewall, and entirely across the base portion.

11. The weather strip according to claim 10 wherein the substructure strip further includes hooks extending outwardly for mating with an opening in a corresponding glass run channel.

12. The weather strip according to claim 1 wherein the first material is polypropylene and the second material is thermoplastic elastomer.

13. The weather strip according to claim 1 wherein the base portion is at least partially formed from a first material.

14. The weather strip according to claim 3 wherein the third material is polyethylene resin.

15. A weather strip for a window in a motor vehicle comprising:
a composite structure including a base portion, a pair of sidewalls, and a pair of sealing members;
the base portion extending lengthwise between a first end and a second end and widthwise between a first edge and a second edge;
the pair of sidewalls including a first sidewall coupled to the first edge of the base portion via a first joint and a second sidewall coupled to the second edge of the base portion via a second joint;
the pair of sealing members including a first sealing member coupled to the first sidewall and a second sealing member coupled to the second sidewall, the first sealing member and the second sealing member being located opposite the base portion and extending towards each other;
each of the sidewalls primarily formed from a strip of a first material;
each of the sealing members being at least partially formed of a strip of a second material; and
wherein the first material is more rigid than the second material.

16. The weather strip according to claim 15 further including a substructure strip of second material that extends between the first sidewall, the second sidewall, and across the base portion and further includes the first joint and the second joint.

17. The weather strip according to claim 15 wherein the first sealing member and the second sealing member both include an external sealing member surface for direct contact with a windowpane during opening and closing, and wherein the external sealing member surface includes a third material having a lower friction index than the first material and the second material for providing a non-abrasive surface.

18. The weather strip according to claim 15 wherein at least one of the first side wall sidewall, the second sidewall, and the base portion includes at least one projection for press fitting into an opening of a corresponding glass run channel, and wherein the projection is formed of the first material or the second material.

19. The weather strip according to claim 18 wherein the at least one projection is formed of the second material.

20. A weather strip for a window of a motor vehicle and a weather strip holding fixture with a corresponding channel for insertion of the weather strip comprising:
the weather strip having a composite structure of a first material and a second material more flexible than the first material, the composite structure including a base portion and at least one sidewall;
the base portion extending lengthwise between a first end and a second end and widthwise between a first edge and a second edge, the at least one sidewall including a first sidewall coupled to the first edge of the base portion;
the weather strip holding fixture defining the channel and including a bottom portion corresponding to the base portion of the weather strip and a side portion corresponding to the at least one sidewall of the weather strip;
at least one projection extending from the base portion or the at least one sidewall of the weather strip; and
at least one opening extending at least partially into the bottom portion or the side portion of the channel in press fit engagement with the at least one projection.
